(19) United States
(12) Patent Application Publication
(10) Pub. No.: US 2010/0138928 A1
(43) Pub. Date: Jun. 3, 2010

(54) APPARATUS AND METHOD FOR SHARING CONTENT BETWEEN DEVICES BY USING DOMAIN DRM

(75) Inventors: Jung Soo Lee, Daejeon (KR); Jung Hyun Kim, Daejeon (KR); Jee Hyun Park, Daejeon (KR); Kisong Yoon, Daejeon (KR); Yeon Jeong Jeong, Daejeon (KR); Do-Won Nam, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/537,550

(22) Filed: Aug. 7, 2009

(30) Foreign Application Priority Data
Dec. 2, 2008 (KR) 10-2008-0120909
Mar. 20, 2009 (KR) 10-2009-0023984

(51) Int. Cl. G06F 21/00; G06F 15/173

(52) U.S. Cl. 726/26; 709/223

(57) ABSTRACT

An apparatus for sharing content between devices by using a domain digital rights management (DRM) includes: a domain management unit for performing management of a domain within a specific area and registration of users and user devices; a user management unit for managing information about the users of the domain registered by the domain management unit; and a device management unit for managing domain clients of the domain registered by the domain management unit. The apparatus further includes a DRM management unit that has DRM information that supports the domain created through the domain management unit and update information about each DRM, and relays such that DRM content stored in each domain client is converted into domain DRM content and domain DRM license.

### CROSS-REFERENCE(S) TO RELATED APPLICATION

The present invention claims priority of Korean Patent Application No. 10-2008-0120909, filed on Dec. 2, 2008 and Korean Patent Application No. 10-2009-0023984, filed on Mar. 20, 2009, which are incorporated herein by reference.

### FIELD OF THE INVENTION

The present invention relates to a content implementation technique, and more particularly, to an apparatus and method for sharing content between devices or between users that allow various devices to freely share content within a digital home by configuring a domain therein for content to which digital rights management (DRM) is applied.

### BACKGROUND OF THE INVENTION

As methods for protecting digital content, there are various protection techniques for allowing a person who is authorized to play the content by applying encryption to the content. A representative one of these techniques is a DRM technique. The DRM technique permits only a person who got authorization to play content through a legal path to play the content because the content itself is encrypted even if someone downloads the content illegally.

An apparatus and process for playing content through DRM will now be described. Content is downloaded from a content server, and a license to play the content is downloaded from a license server through a purchase process. The copyright holder of the content can set up an authority to use the content through this license, and prevent illegal distribution of the content.

However, there is a drawback that the DRM is unfavorable to rightful users since content can be played only in a device that downloaded it due to the closed character of the DRM.

To solve this problem, various methods have been studied and developed.

Among these, MPEG-21 provides standards for protection and management of multimedia content by introducing architecture and interfaces between intellectual property management and protection (IPMP) tools. MPEG IPMP does not standardize IPMP itself, but introduces the interfaces and architecture between tools, which allows flexibility of the IPMP internal technology. That is, MPEG IPMP provides interoperability between heterogeneous devices by searching for and installing DRM tools whenever they are needed if DRMs applied to content to be shared are different from each other. However, it is practically difficult to apply a method of playing content after searching for an appropriate DRM tool and installing the same when it is desired to use content protected by DRM. A platform on which the DRM can run is restricted and it is almost impracticable to install all of required DRM tools each time it is desired to use content which is protected. Since every device is under different installation environments, and a storage device for installing a DRM or a resource such as computing power has its limitations, the MPEG IPMP is a technology that is difficult to apply in practice.

Digital media project (DMP) released a comprehensive technology specification for interoperable DRM. DRM functions can be decomposed into smaller primitive functions, which are implemented by an interoperable DRM platform (IDP) toolkit. Unlike MPEG that simply defines an architecture and interfaces, the DMP defines its own DRM formats, such as DRM/authentication messages, domain/access protocols, and so on.

This method seems to be one of the most complete ways of providing interoperability at first glance. In principle, it is difficult for one DRM to have a comprehensive architecture introduced in the DMP, and this approach should accompany disclosure of the entire structure of DRM.

In case of export/import (EXIM), one intermediate DRM format is set so that interoperability is achieved through this intermediate format between different DRMs. That is, this approach is a method of using content in which a DRM A is changed into a defined intermediate format through an export module and a DRM B changes this into its own DRM through an import module. The EXIM has an advantage that two DRMs participating in an interoperation can share content without disclosing their DRM architectures or contents. However, the intermediate format has to have comprehensive contents to substitute for the license structures of the two DRMs, and it is difficult to match the license contents of the two DRMs.

The coral consortium establishes a trusted third party (TTP), and depends on the TTP when sharing different DRM contents. However, each device has to be provided with network equipment, and whenever one DRM is added to the TTP, interoperability with previously installed DRMs should be achieved.

Open mobile alliance (OMA) represents an import module for importing into an OMA system from other DRMs and an export module for exporting to other DRMs. To this end, a domain is defined and used to share content between devices on which an OMA DRM is mounted, and the devices that joined to the domain can share and use content. However, since a server managing the domain manages all of authority information, content information and the like. associated with DRM, the load of the server is high and thus it is difficult to use the OMA in a general home environment. Moreover, unless OMA DRM is applied, it is difficult to use the domain function defined in the OMA.

Also, Marlin made a simple DRM for sharing content within a digital home by introducing the concept of domain. This DRM is designed such that a member who joined to the domain can use content without accessing the domain server and content can be freely shared within the domain by using the concept of links and nodes. However, the Marlin also has a drawback that it can use the domain only by employing its own DRM, and it is difficult to apply this approach to other DRMs.

As mentioned above, although various studies have been made with respect to the content encryption method according to the prior art operating as above, there is a problem that it is inconvenient or difficult for a user to use in various aspects because the user has to pay again for content when the user wants to use downloaded content in other devices of the user since the content can be played only in a user device that downloaded the content due to the closed character of the DRM.

### SUMMARY OF THE INVENTION

Therefore, the present invention provides an apparatus and method for sharing content between devices in a digital home by using a domain DRM which configures a domain through a universal plug and play (UPnP) constituting a home network and allows domain members to freely use content through the domain regardless of devices or installed DRMs.

The present invention further provides an apparatus and method for sharing content between devices within a digital home by using a domain DRM which allows domain clients to share content by setting a relationship about management, such as creation and deletion of a domain and join to and leave from a domain, between a domain server and the domain clients in order to allow devices of home members to freely use content DRM applied content has entered the digital home regardless of a DRM installed on each device.

In accordance with a first aspect of the present invention, there is provided an apparatus for sharing content between devices by using a domain digital rights management (DRM).

The apparatus includes: a domain management unit for performing management of a domain within a specific area and registration of users and user devices; a user management unit for managing information about the users of the domain registered by the domain management unit; a device management unit for managing domain clients of the domain registered by the domain management unit; and a DRM management unit that has DRM information that supports the domain created through the domain management unit and update information about each DRM, and relays such that DRM content stored in each domain client is converted into domain DRM content and domain DRM license.

In accordance with a second aspect of the present invention, there is provided an apparatus for sharing content between devices by using a domain DRM.

The apparatus includes: a domain management module for requesting a domain server to make a domain and managing a domain ID and a domain key transmitted from the domain server through domain join; a device management module for making a request to the domain server for device registration and registering a device through authentication; a user management module that has information about users who use the device; a content management module for providing DRM content information to manage domain information about stored content and change the content into a domain DRM in conjunction with the domain management module; and a DRM management module for managing information of the DRM in the device in conjunction with the domain management module and changing the DRM content stored in the content management module into a domain DRM format, or converting the content encrypted with a domain DRM into a DRM format installed in the device.

In accordance with a third aspect, there is provided a method for sharing content between devices by using a domain DRM, including: upon receipt of a request to make a domain from a specific domain client, performing domain creation through device authentication and transmitting information of the creation of the corresponding domain to the specific domain client; upon receipt of a request for join to the created domain from the domain client, performing domain join through authentication; and relaying such that DRM content stored in each domain client is converted into domain DRM content and domain DRM license so as to support content search among domain clients that joined to the domain and enable play of searched DRM content.

### BRIEF DESCRIPTION OF THE DRAWINGS

The above and other objects and features of the present invention will become apparent from the following description of preferred embodiments, given in conjunction with the accompanying drawings, in which:

FIG. 1 is a view showing a relationship between a domain server and a domain client within a digital home in accordance with an embodiment of the present invention;

FIG. 2 illustrates a detailed block diagram of the domain server in accordance with the embodiment of the present invention;

FIG. 3 illustrates a detailed block diagram of the domain client in accordance with the embodiment of the present invention;

FIGS. 4A and 4B are views showing a procedure for sharing the DRM applied contents using a domain in accordance with the present invention;

FIGS. 5A and 5B are views showing a method of searching for content registered in a domain through UPnP in accordance with the embodiment of the present invention;

FIGS. 6A and 6B are views showing a procedure of registering content in a domain in accordance with the embodiment of the present invention; and

FIGS. 7A and 7B are views showing a procedure of converting content registered in a domain into the DRM of a device in order to play the content in the device itself, in accordance with the embodiment of the present invention.

### DETAILED DESCRIPTION OF THE EMBODIMENT

Hereinafter, the operational principle of the present invention will be described in detail with reference to the accompanying drawings. In the following description, well-known functions or constitutions will not be described in detail if they would obscure the invention in unnecessary detail. Further, the terminologies to be described below are defined in consideration of functions in the present invention and may vary depending on a user's or operator's intention or practice. Thus, the definitions should be understood based on all the contents of the specification.

In the present invention, a domain is configured for content to which DRM is applied by a home network configuration method, such as UPnP or HAVi, for configuring a home network within a digital home, i.e., a specific zone, area and group, so that the content registered in the configured domain can be freely used between domain members regardless of a DRM installed on devices.

When content to which DRM is applied is downloaded by a specific device, the content can be played only in a device that downloaded it. However, a user who purchased the content in a rightful way may want to play the downloaded content in other devices owned by the user, more extensively, in devices of families or friends located in the digital home, as well as in his or her devices. In this case, a method or apparatus for sharing the DRM applied content between users or between devices is required. Further, when a digital home becomes active, it is necessary to share content to which DRM is applied between various users or devices configuring the digital home.

A process for sharing content will be described by way of example.

First, it is assumed that a certain user downloads a movie file in his or her PDA device. When it is also assumed that this movie file is protected by DRM and a key to which the movie file is encrypted is encrypted by a device key of the PDA device to issue a license to the user, the user may want to share this movie file with his or her families and watch it not through the PDA but through a TV or a computer monitor. To this end, the user first creates a domain if there isn't any, and registers the downloaded file in the created domain. The movie registered in the domain can be freely used by other users who will join to the domain in their own devices or devices configuring a digital home.

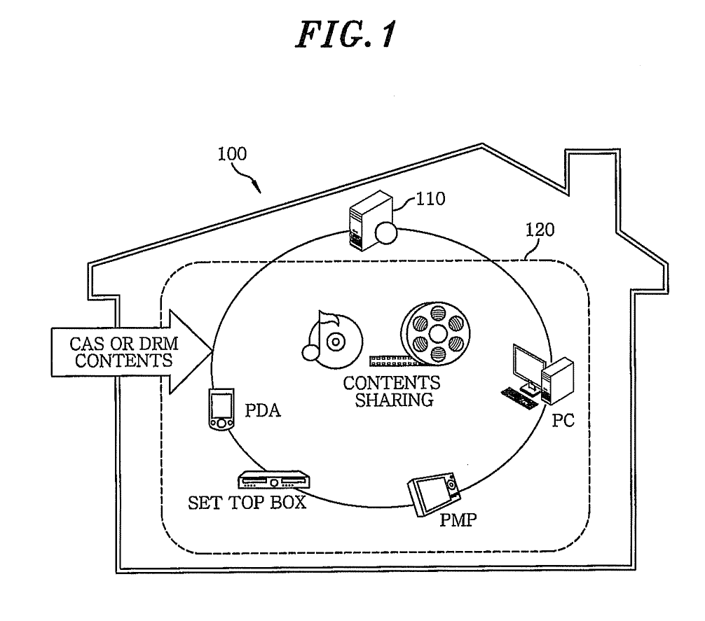

FIG. 1 is a view showing a relationship between a domain server and a domain client within a digital home in accordance with an embodiment of the present invention. Referring to FIG. 1, a digital home 100 is configured such that content to which DRM is applied is freely used between home members (users, devices and the like) regardless of a DRM installed on each device. That is, the content is shared on the domain by setting a relationship about management, such as creation and deletion of a DRM domain and join to and leave from a domain, using a home network (e.g., UPnP, HAVi and the like) between a domain server 110 and a domain client 120.

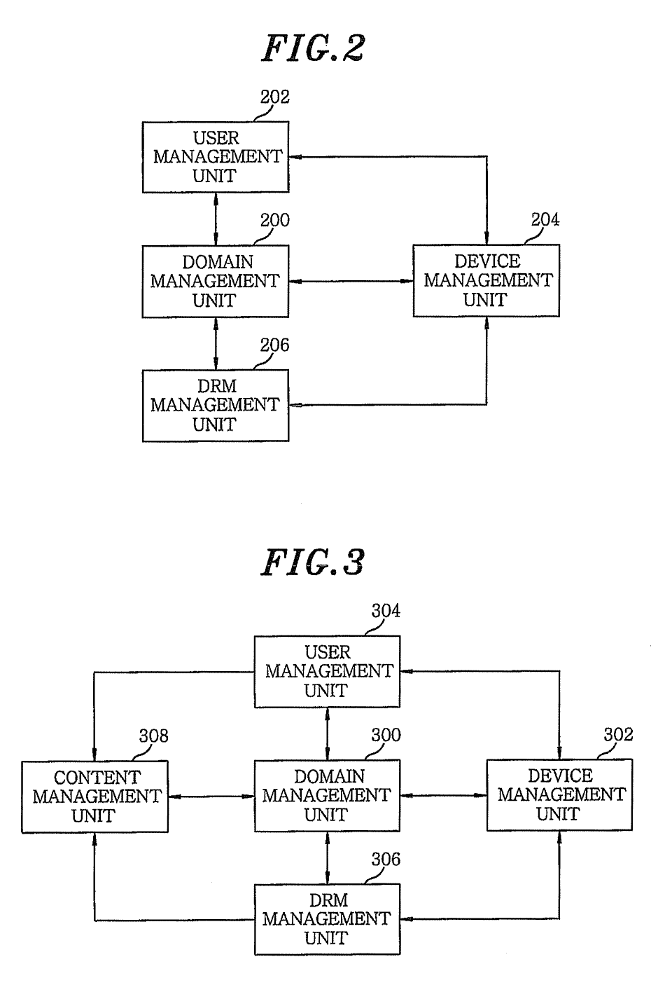

FIG. 2 shows a detailed block diagram of the domain server in accordance with the embodiment of the present invention.

Referring to FIG. 2, the domain server 110 includes a domain management unit 200, a user management unit 202, a device management unit 204, and a DRM management unit 206.

The domain management unit 200 is in charge of the management of a domain, such as creation, deletion, modification of the domain, and joining to and leaving from the domain. Further, the domain management unit 200 contains information about the management of each created domain, an entity who created the domain, and users or devices that joined to the domain, and contains DRM information supporting domain currently by interoperation with the DRM management unit 206 and latest update information of each DRM.

The user management unit 202 contains information about families within the digital home or information about user members of a small group. In order for a user to join the digital home or group at first, a procedure of registering the user in the domain is required. To this end, the user management unit 202 includes user information registered through the domain management unit 200.

The device management unit 204 requires a procedure of registering a device in the domain so as to use the device in the digital home or a specific group. When a device is registered in the digital home through the domain management unit 200, management is performed later through the device management unit 204. To this end, in order to register a user device as a domain client through the domain management unit 200, a procedure of recognizing information of a DRM installed on the user device and checking whether or not the installed DRM supports the domain is required.

The DRM management unit 206 manages the DRM that supports the present domain, and has latest DRM information. User devices, i.e., domain clients in the digital home 100 can disable the DRM applied to the content in order to register the content in a created domain, and perform conversion of the content into a domain DRM content and issue a domain DRM license based on the previous DRM license a domain DRM license. The converted content is duplicated or streamed (transmitted) to the device that has requested the content, and the transmitted domain content and domain license are converted into a DRM installed on the domain client who has requested the content. At this time, the domain server 110 is only in charge of relaying between devices, and actual conversion of the content and the license is done at both of the device that has received the request for the content and the device that has requested the content, i.e., both of the domain clients. However, a device that has an insufficient computing power may request the domain server 110 for conversion of content. In this case, the DRM management unit 206 may perform disabling of DRM, conversion into a domain DRM license and a domain DRM content or conversion of a domain DRM license, and a domain DRM content into DRMs of respective devices.

FIG. 3 illustrates a detailed block diagram of the domain client in accordance with the embodiment of the present invention.

Referring to FIG. 3, the domain client 120 includes a domain management module 300, a device management module 302, a user management module 304, a DRM management module 306, and a content management module 308.

The domain management module 300 manages a domain to which it joined, and a domain ID and a domain key corresponding to each domain. The domain ID and the domain key are received from the domain server 110 after completion of approval of join to a specific domain. Also, the domain management module 300 updates key changes by other users' join/leave to/from the domain by managing version information about the domain key. Further, the domain management module 300 performs changing license of content into a domain license by using the domain key. That is, when the content and the license need to be changed from A DRM to B DRM, a DRM changing operation is performed not by directly connecting the two DRMs for each user device but through an intermediate DRM (for example, a domain DRM). In other words, if there is a need for a change from the A DRM of a first user device to the B DRM of a second user device, the A DRM of the first user device is changed to a domain DRM, and then transmitted to the second user device. Then, the B DRM of the second user device changes the domain DRM to its own B DRM to use the content and the license. Such a change to the domain DRM is performed through the DRM management module 306 in conjunction with the domain management module 300.

The device management module 302 manages information about its own device. Upon join to/leave from the domain, a request for information is made to the domain server 110 from the device management module 302 to perform authentication of the device. Since there may be multiple users for one device, the user management module 304 is used to manage various user information about the device.

The DRM management module 306 is used to manage DRM information used for the device and perform a change to a domain DRM or a change of content composed of a domain DRM into a DRM format installed in the device in conjunction with the domain management unit 300.

The content management module 308 manages domain information about content, and provides information for registering information about content or information for changing into a domain DRM when converting the content into a DRM format in the device in conjunction with the domain management module 300 and the DRM management module 306. Here, the information about content may be at least one of information about a domain client where the corresponding content is stored, domain information, codec information in use, and DRM information.

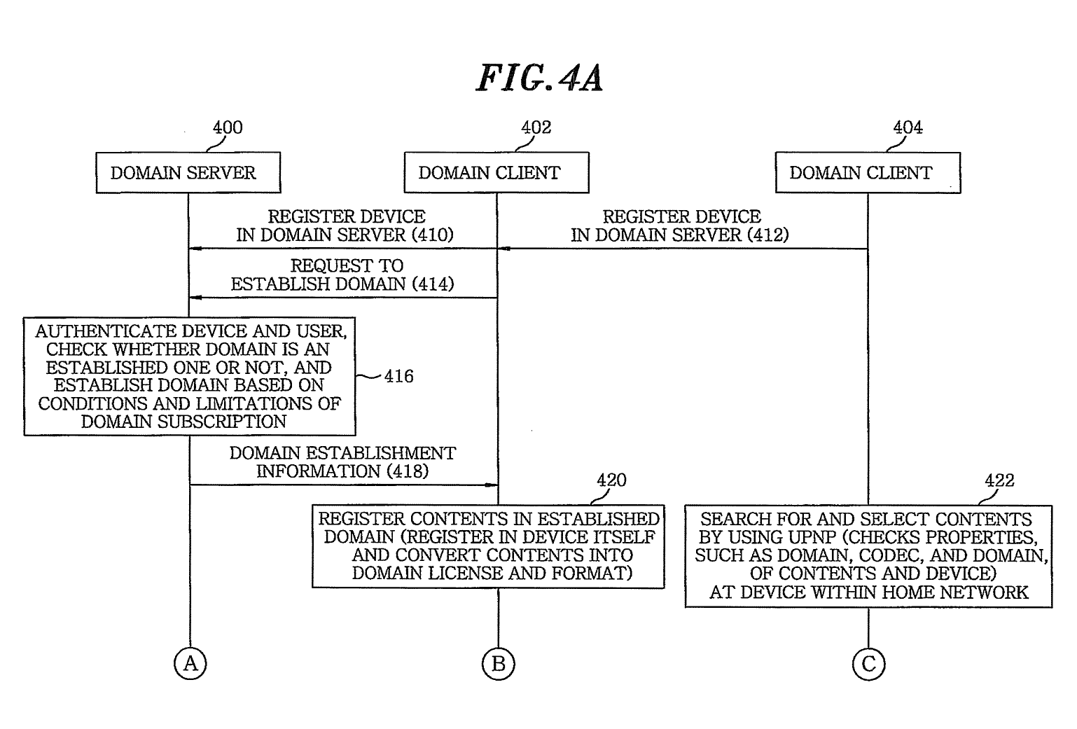

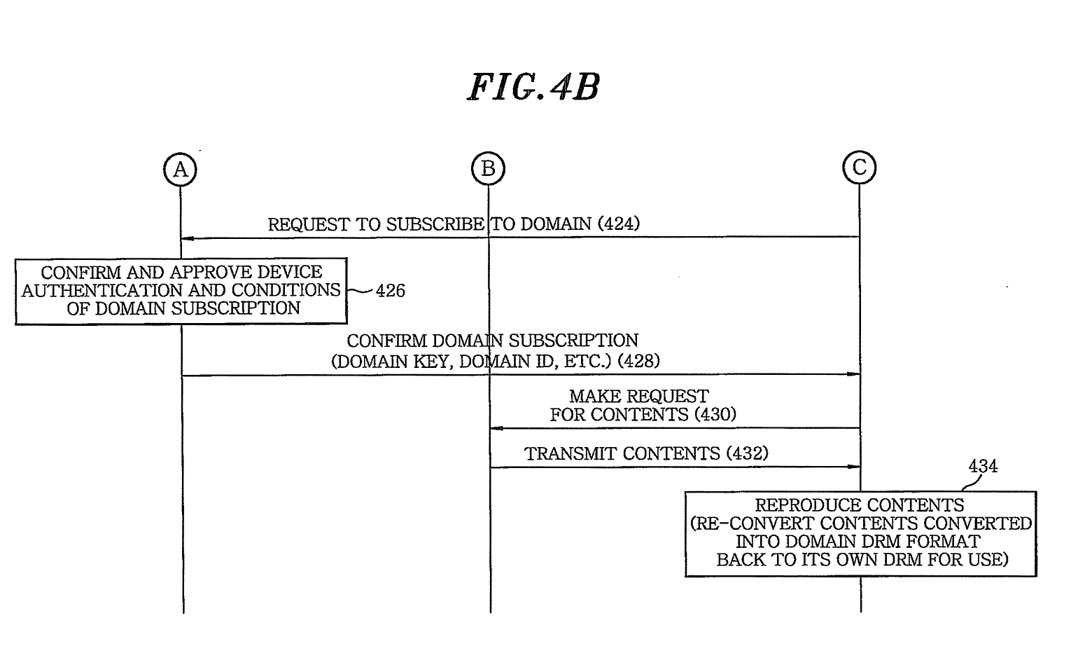

FIGS. 4A and 4B are views showing an operation procedure for sharing the DRM applied content using a domain DRM in accordance with the present invention.

Referring to FIGS. 4A and 4B, it is assumed that if a domain server 400 and two clients, a domain client 402 and a domain client 404, that provide content and share the provided content are configured in a digital home, the devices are tied by a digital home network (e.g., UPnP, HAVi and the like).

First, both of the domain client 402 and the domain client 404 have to be registered in the domain server 400. To this end, in step 410, the domain client 402 performs device registration in the domain server 400, and in step 412, the domain client 404 performs device registration in the domain server 400.

Here, the domain client 402 is an entity that makes a domain and registers content and corresponds to a media server, while the domain client 404 is an entity that uses the shared content and corresponds to a media renderer. It is not necessary for the two clients 402 and 404 to have the same DRM installed thereon.

Next, if the domain client 402 requests the domain server 400 to make a domain in step 414, the domain server 400 receives various items (for example, device information, user information, a DRM in use, codec information, and so forth) required to make a domain from the domain client 402; and the domain server 400 authenticates the device that has requested to make a domain (for example, checks whether the device is the one registered in the domain server or not) and checks whether or not the domain is a created domain already in step 416. If the domain is not a created domain, the domain server 400 makes the requested domain, and it sends information associated with the created domain, such as the domain ID and the domain key, to the domain client 402 in step 408.

Then, the domain client 402 registers content in the created domain in step 420. The registration procedure can be done independently without access to the server. At this time, the license is converted into a domain DRM license, and the content is also converted into a domain DRM content. That is, since the domain DRM is the intermediate type that all of domain clients can convert into its own DRM installed to each device and use; it makes the DRM applied contents to be shared in digital home. Further, the domain client 402 can set up whether or not to permit other domain clients to search for the content registered in a specific domain through the home network.

When the domain client 404 searches for and selects content shared over the digital home or registered in a specific domain through the home network in step 422, information about the selected content is transmitted to a control point of a computing device to which the home network is connected. At this time, the control point may be the domain server 400. Based on this information, if the domain client 404 has not yet joined to the domain in which the corresponding content is registered, a procedure of joining to the domain is required additionally.

If the domain client 404 has not yet joined to the domain, the domain client 404 requests the domain server 400 for join to the corresponding domain in step 424. Then, the domain server 400 checks whether or not the domain client 404 can join to the domain in step 426, and if so, sends a domain join confirmation message containing domain information such as the domain key and the domain ID to the domain client 404 in step 428. After that, since the selected content is in the domain client 402, the domain client 404 requests the domain client 402 to transmit the content in step 430. Then, the domain client 402 transmits the requested corresponding content data (which is the content converted into the domain DRM content and the license) to the domain client 404 in step 432.

By this, the domain client 404 converts the content information received from the domain client 402 into the DRM format installed on the device and performs play in step 434.

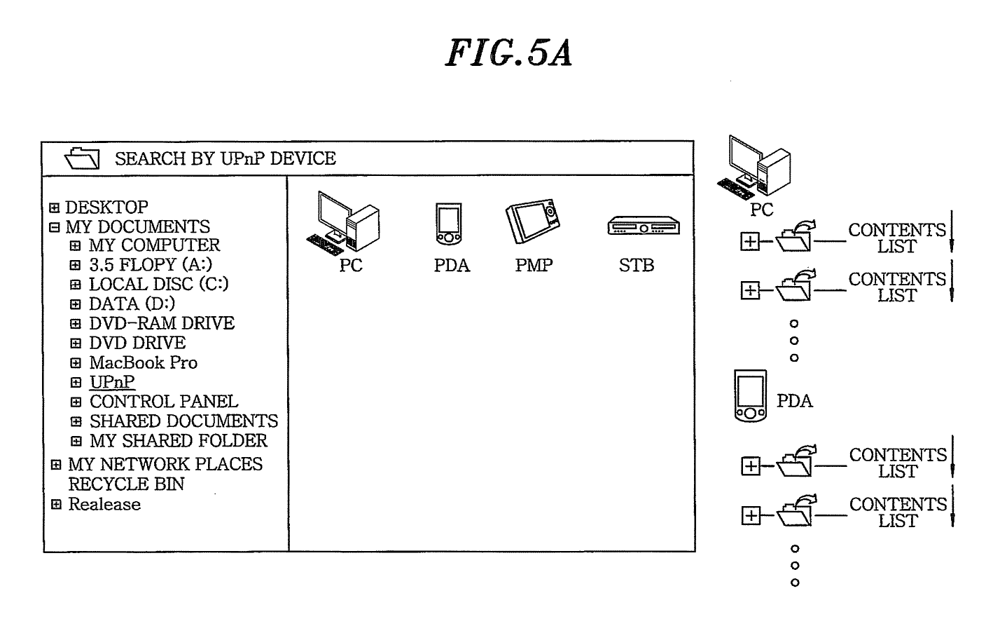

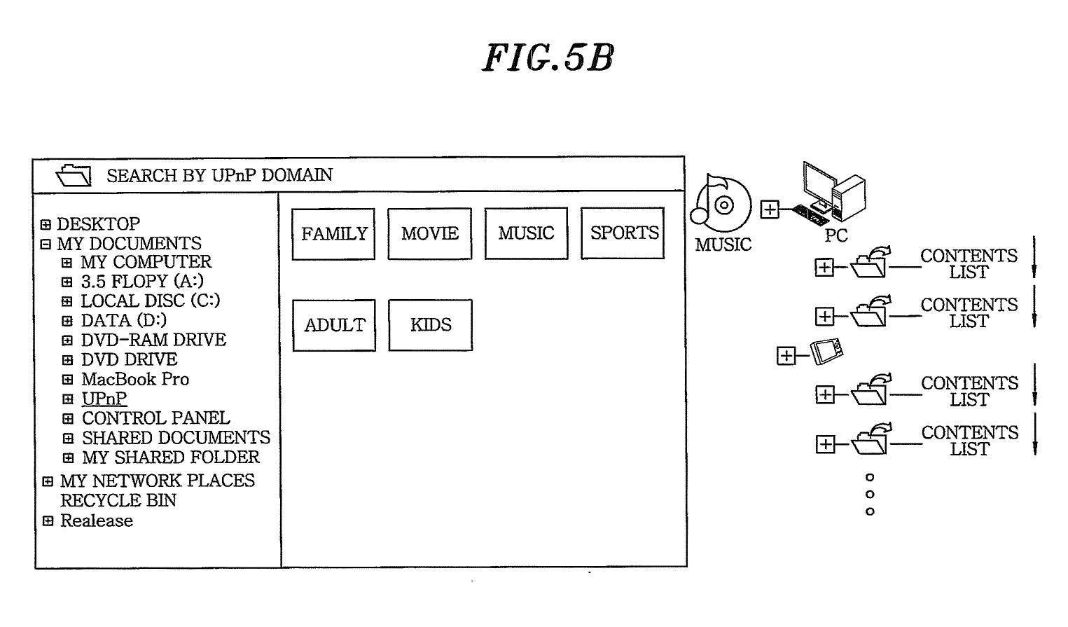

FIGS. 5A and 5B are views showing a method of searching for content registered in a domain through UPnP in accordance with the embodiment of the present invention.

FIG. 5A illustrates a method of searching by device. Although devices in the home network uses a browsing method of UPnP as it is, the devices are marked as a device registered in the domain server and a device supporting only UPnP. After selecting a device registered in the domain server, when content in the device is selected, information about in which domain the content is registered is sent to the control point of the computing device.

If the device has joined to the corresponding domain, it may request for the content and use the content, and if not, the device may join to the domain and then use the content. That is, communication between the domain server and the domain client in the home network is done to such an extent as to display other domain client devices; and once a device is selected, content can be selected and used through communication with the selected device.

FIG. 5B shows a method of searching by domain. First, when a domain is selected, devices belonging to the corresponding domain are displayed. Similarly, the domain server is in charge of the role of showing the devices belonging to the domain, and the subsequent process is done with respect to the selected device. The difference between the method of searching by domain and the method of searching by device is how content is displayed upon selection of a device.

That is, the method of searching by device displays all contents contained in the device, while the method of searching by domain displays only a content contained in the corresponding domain. Upon searching by domain, a device is selected and then content stored in the selected device is selected. The subsequent steps are performed in the same manner as when selecting by device.

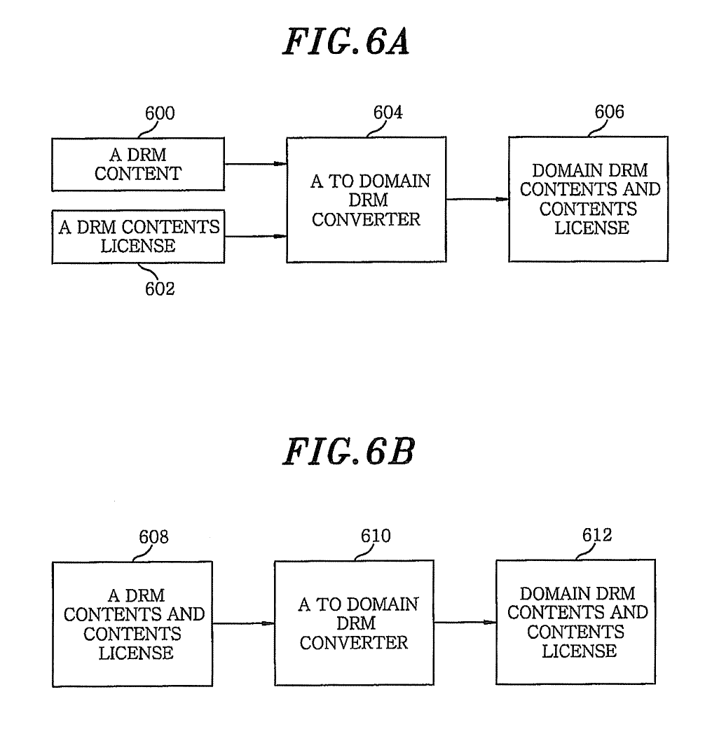

FIGS. 6A and 6B are views showing a procedure of registering content in a domain in accordance with the embodiment of the present invention, which shows that a domain client converts the DRM content and license of a device into a domain DRM through the procedure of registering the content in the domain.

The procedure of registering content in a domain refers to converting a content and license stored in a domain client into a domain DRM. When it is assumed that A DRM content is registered in a domain and a device having a B DRM installed thereon uses the content registered in the domain, the format of A DRM may be largely divided into two types: a format in which the content and the license are separated from each other as shown in FIG. 6A and a format in which the content and the license are provided together as shown in FIG. 6B.

Referring to FIG. 6A, if an A DRM content 600 and an A DRM content license 602 are separately stored in a specific domain client, they are transmitted to an A to domain DRM converter 604. Then, the A to domain DRM converter 604 performs conversion to a domain DRM to store the content and the license in one bound format, i.e., in the format of domain DRM content and content license 606.

Also, referring to FIG. 6B, if A DRM content and content license 608, which are provided in a bound format, are stored in a specific domain client, they are transmitted to the A to domain DRM converter 610. Then, the A to domain DRM converter 610 performs conversion to a domain DRM to store them as domain DRM content and content license 612.

When the A to domain DRM converters 604 and 610 are configured and conversion to a domain DRM is performed on the basis of these two formats, the content and the license are stored in one bound format. This is to enable a specific domain client, which is a media renderer, to quickly output domain information of the content upon clicking the corresponding content and achieve convenience of utilization of the content in the domain.

Meanwhile, the A to domain DRM converters 604 and 610 are implemented through a domain client where the corresponding content and license are stored, and information converted into a domain DRM in the corresponding domain client is transmitted later to a domain client that has requested the corresponding content. Then, the domain client that has received the information converted into the domain DRM converts this into its own DRM and performs play.

However, in case where no domain DRM converter is included in the corresponding domain client, that is, the domain client is a device only capable of playing stored content, the stored content and license are transmitted to the domain server to request conversion of this to a domain DRM. Then, the content and license of the converted domain DRM format are received from the domain server.

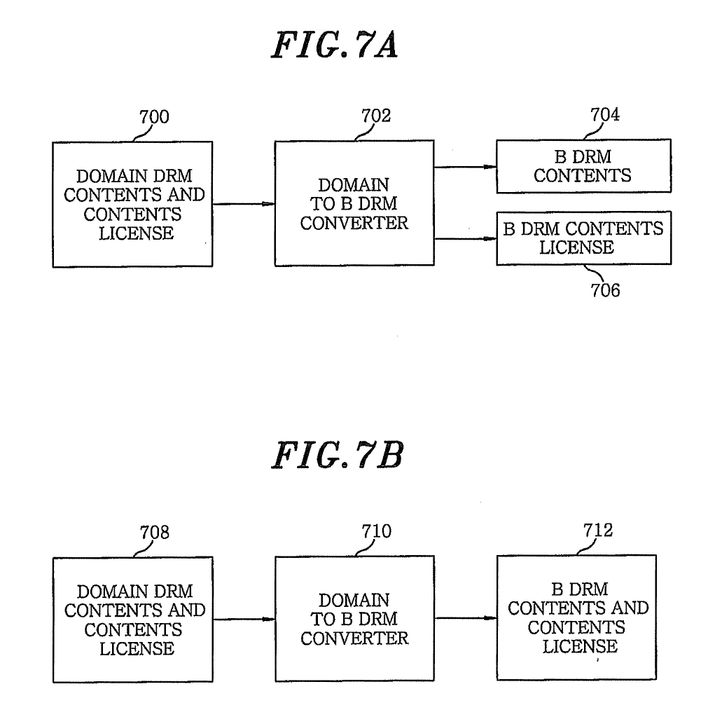

FIGS. 7A and 7B are views showing a procedure of converting content registered in a domain into the DRM of a device in order to play the content in the device itself, in accordance with the embodiment of the present invention.

In FIGS. 7A and 7B, when content is fetched under the assumption that a device is registered in a domain in order to utilize the content registered in the domain, the content is converted into a B DRM installed on the device itself because the content is packaged in a domain DRM.

Specifically, as shown in FIG. 7A, if domain DRM content and license 700 converted into the domain DRM format is received as the content selected by a user device serving as a domain client, the domain DRM content and license 700 is separated into B DRM content 704 and B DRM content license 706 through a domain to B DRM converter 702. By virtue of this, the user device plays content of a B DRM format.

Also, as shown in FIG. 7B, if domain DRM content and license 708 selected by the domain client is received, this is converted into a format of B DRM content and license 712 by using a domain to B DRM converter 710.

The domain DRM content and license 708 may be played in different formats for user devices, and thus is converted into a format in which the B DRM content 704 and the B DRM content license 706 are separated from each other or a format in which they are bound together as the B DRM content and license 712.

As above, the A to domain DRM converters 604 and 610 of FIGS. 6A and 6B include a module for decoding A DRM and a module for applying a domain DRM, and the domain to B DRM converters 702 and 710 of FIGS. 7A and 7B include a module for decoding a domain DRM and a module for applying B DRM. Since the domain DRM is in a format which is disclosed as an intermediate data form, the A to domain DRM converters 604 and 610 are manufactured by a manufacturer who made A DRMs and the domain to B DRM converters 702 and 710 are manufactured by a manufacturer who made B DRMs. Thus, there is no need to disclose their DRM technology for conversion between the two DRMs. Further, since it is not necessary to change the current DRM in order to apply the current DRM to a domain, it is needless to say that domain application is possible for all DRMs.

Moreover, when storing content received through IPTV in a PVR system, DRM is generally applied in case of content requiring copyright protection. Because conditional access system (CAS) is applied to IPTV content, the present content sharing method using a domain is also applicable to the IPTV content. That is, the domain server converts content of CAS format into content of domain DRM format for use.

As described above, the present invention configures a domain through UPnP constituting a digital home, i.e., a home network for content to which DRM is applied, to thereby allow domain members to freely use the content through the configured domain regardless of devices or installed DRMs.

The present invention is not limited to DRM or CAS, any security techniques that can manage digital copyrights and prevent illegal duplication are applicable.

As a result, the present invention can prevent illegal distribution of content in advance upon activation, and thus, the copyright holder of content gets properly paid for content created by themselves and a user can freely use the content by paying a certain amount of money. Although the content is played within the license (content play period, number of times, rules of use, and so on) specified by the copyright holder, the content can be freely used among the members of the domain. Moreover, the content can be played regardless of a DRM installed on the device through a DRM interoperability module, and this offers convenience to a rightful user, thereby reducing the feeling of rejection from users and activating the use of content.

While the invention has been shown and described with respect to the preferred embodiments, it will be understood by those skilled in the art that various changes and modifications may be made without departing from the scope of the invention as defined in the following claims.

What is claimed is:

1. An apparatus for sharing content between devices by using a domain digital rights management, comprising:
a domain management unit for performing management of a domain within a specific area and registration of users and user devices;
a user management unit for managing information about the users of the domain registered by the domain management unit;
a device management unit for managing domain clients of the domain registered by the domain management unit; and
a DRM management unit that has DRM information that supports the domain created through the domain management unit and update information about each DRM, and relays such that DRM content stored in each domain client is converted into domain DRM content and domain DRM license.

2. The apparatus of claim 1, wherein the domain management unit provides functions of creation and deletion of the domain and join to and leave from the domain in response to a user device's request.

3. The apparatus of claim 1, wherein the domain management unit provides information about a device and content registered in a domain to which the domain client is joined to other domain clients.

4. The apparatus of claim 3, wherein the information about content is at least one of information about a domain client where the corresponding content is stored, domain information, codec information in use, and DRM information.

5. The apparatus of claim 1, wherein the DRM management unit converts specific DRM content and license into domain DRM content and license of the corresponding domain in response to a domain client's request.

6. An apparatus for sharing content between devices by using a domain DRM, comprising:
a domain management module for requesting a domain server to create a domain and managing a domain ID and a domain key transmitted from the domain server through domain join;
a device management module for making a request to the domain server for device registration and registering a device through authentication;
a user management module that has information about users who use the device;
a content management module for providing DRM content information to manage domain information about stored content and change the content into a domain DRM in conjunction with the domain management module; and
a DRM management module for managing information of the DRM in the device and changing the DRM content stored in the content management module into a domain DRM in conjunction with the domain management module, or converting the content comprised of a domain DRM into a format of DRM content installed in the device.

7. The apparatus of claim 6, wherein the domain management module converts a license of content into a domain DRM license based on the domain key in conjunction with the DRM management module.

8. The apparatus of claim 6, wherein the domain management module registers information on content stored in the content management module in a created domain.

9. The apparatus of claim 8, wherein the information about content is at least one of information about a domain client where the corresponding content is stored, domain information, codec information in use, and DRM information.

10. The apparatus of claim 6, wherein the domain management module receives domain DRM content through search and selection of content of a domain client joined on a domain via a home network, and transfers the domain DRM content to the content management module.

11. A method for sharing content between devices by using a domain DRM, comprising:
upon receipt of a request to make a domain from a specific domain client, performing domain creation through device authentication and transmitting information of the creation of the corresponding domain to the specific domain client;
upon receipt of a request for join to the created domain from the domain client, performing domain join through authentication; and
relaying such that DRM content stored in each domain client is converted into domain DRM content and domain DRM license so as to support content search among domain clients who joined to the domain and enable play of searched DRM content.

12. The method of claim 11, further including: upon receipt of a request for device registration from a user device corresponding to each domain client, performing the device registration through authentication of the user device.

13. The method of claim 11, wherein said relaying provides information about a device and content registered in a domain to other domain.

14. The method of claim 13, wherein the information about content is at least one of information about a domain client where the corresponding content is stored, domain information, codec information in use, and DRM information.

15. The method of claim 11, further including:
receiving a request for conversion into a disclosed domain DRM from the domain client; and
converting DRM content and license stored in the domain client into domain DRM content and license of the corresponding domain in response to the request.

16. A method for sharing content between devices by using a domain DRM, comprising:
upon requesting a domain server to create a domain, receiving domain creation information through device authentication;
converting stored DRM content into a domain DRM content and license format and registering converted domain DRM content and license in the created domain; and
permitting a specific domain client who joined to the created domain to search for content and transmitting the corresponding content of the domain DRM content and license format converted in response to a content request to the specific domain client.

17. The method of claim 16, further including: performing registration of a user device prior to requesting the domain server to create a domain.

18. A method for sharing content between devices by using a domain DRM, comprising:
selecting desired content by performing content search via a home network;
if a device has not yet joined to the domain for the selected content, making a request for join to a created domain through a domain server;
if the device has joined to the created domain through device authentication of the domain server, receiving a corresponding domain ID and key; and
requesting the domain client storing the selected content to receive the corresponding content of the domain DRM content and license format.

19. The method of claim 18, further including: performing registration of a user device prior to requesting the domain server to create a domain.

20. The method of claim 18, further including: converting the content of the received domain DRM content and license format into content and license of DRM format in the device.
